(19) United States
(12) Patent Application Publication
(10) Pub. No.: US 2020/0275116 A1
(43) Pub. Date: Aug. 27, 2020

(54) ATYPICAL BLOCK-BASED MOTION PREDICTION AND COMPENSATION METHOD FOR VIDEO ENCODING/DECODING AND DEVICE THEREFOR

(71) Applicants: ELECTRONICS AND TELECOMMUNICATIONS RESEARCH INSTITUTE, Daejeon (KR); Ewha University - Industry Collaboration Foundation, Seoul (KR)

(72) Inventors: Gun BANG, Daejeon (KR); Je Won KANG, Seoul (KR); Na Young KIM, Seoul (KR)

(73) Assignees: ELECTRONICS AND TELECOMMUNICATIONS RESEARCH INSTITUTE, Daejeon (KR); Ewha University - Industry Collaboration Foundation, Seoul (KR)

(21) Appl. No.: 16/491,361

(22) PCT Filed: Mar. 13, 2018
(86) PCT No.: PCT/KR2018/002949

§ 371 Date: Sep. 5, 2019

(30) Foreign Application Priority Data
Mar. 13, 2017 (KR) 10-2017-0031085

(51) Int. Cl. H04N 19/513; H04N 19/176; H04N 19/563; H04N 19/597; H04N 19/533

(52) U.S. Cl. CPC H04N 19/513; H04N 19/176; H04N 19/533; H04N 19/597; H04N 19/563

(57) ABSTRACT

Disclosed is a method and apparatus for deformable block based motion prediction for video encoding/decoding. According to an embodiment of the present disclosure, a method of deformable block based motion prediction includes: detecting format information of a 360-degree video, deforming at least one of a form of a current block and a form of a neighbor block by using the format information, and predicting a motion vector for the current block based on the deformation.

### TECHNICAL FIELD

The present disclosure relates to a method and apparatus for deformable block based motion prediction and compensation for video encoding/decoding. More particularly, the present disclosure relates to a method and apparatus for deformable block based motion prediction and compensation for video encoding/decoding in consideration of a video characteristic in 360-degree video encoding/decoding.

### BACKGROUND ART

Recently, as demands for high-resolution and high-quality video service such as ultra high definition (UHD) video service, etc., have increased, a video coding standard such as high efficiency video coding (HEVC) has been developed. HEVC divides one slice into Coding Tree Units (CTUs), and each CTU is recursively divided in quad tree form. FIG. 7 is a view schematically illustrating a partition structure of an image when encoding and decoding the image. Referring to FIG. 7, a unit to be divided is a coding unit (CU), and each CU may be partitioned into various prediction units (PUs) such as 2N×2N, N×2N, 2N×N, N×N, an asymmetric partition structure (asymmetric motion partitions, AMP), etc.

In the meantime, a 360-degree video photographing apparatus may be generally categorized into a rig type and an all-in-one type. FIG. 8 is a view illustrating a 360-degree video photographing apparatus according to an embodiment of the present disclosure. Referring to FIG. 8, the all-in-one type 810 may mean a camera in which the single camera photographs at 360 degrees via a fisheye lens, etc. The rig type 820 may mean multiple cameras connected to each other for photographing. A stitching process is performed on videos obtained using the all-in-one type 810 or the rig type 820 such that a 360-degree video in an equirectangular format may be typically obtained.

The 360-degree video may have various projection formats. FIG. 9 is a view illustrating projection formats of the 360-degree video according to an embodiment of the present disclosure. Referring to FIG. 9, the 360-degree video is formatted in an ERP (equirectangular projection) 910, an ISP (icosahedral projection) 920, a CMP (cube map projection) 930, an OCP (octahedron projection) 940, a tetrahedron (not shown), a dodecahedron (not shown), etc. Among the various projection formats, the projection format that is typically used (i.e., native) for the 360-degree video is ERP. FIG. 10 is a view illustrating an ERP video according to an embodiment of the present disclosure. The ERP video is a video projected on a sphere surface divided into the same areas on the basis of latitude and longitude. Referring to FIG. 4, on the basis of the camera, a video 1010 mapped to a 360-degree sphere is projected in 2D, whereby an ERP video 1020 is obtained.

FIG. 11 is a view illustrating ERP distortion according to an embodiment of the present disclosure. Referring to FIG. 11, moving up and down in the ERP video with respect to the equator may cause distortion in which the video is stretched left and right. For example, it is stretched by

$$\frac{1}{cos ϕ}$$

with respect to the latitude.

Thus, motion estimation and compensation techniques for an ERP video by using a conventional block based motion estimation technique are inappropriate due to distortion occurring in the ERP video, and studies complementing this have been discussed.

### DISCLOSURE

### Technical Problem

An object of the present disclosure is to provide a method and apparatus for deformable block based motion prediction for video encoding/decoding.

Another object of the present disclosure is to provide a method and apparatus for deformable block based motion compensation for video encoding/decoding.

Another object of the present disclosure is to provide a method and apparatus for performing deformable block based motion prediction in consideration of a video characteristic in 360-degree video encoding/decoding process.

Another object of the present disclosure is to provide a method and apparatus for performing deformable block based motion compensation in consideration of a video characteristic in 360-degree video encoding/decoding process.

It is to be understood that technical problems to be solved by the present disclosure are not limited to the aforementioned technical problems and other technical problems which are not mentioned will be apparent from the following description to a person with an ordinary skill in the art to which the present disclosure pertains.

### Technical Solution

According to one aspect of the present disclosure, there is provided a method of deformable block based motion prediction, the method comprising: detecting format information of a 360-degree video; deforming at least one of a form of a current block and a form of a neighbor block by using the format information; and predicting a motion vector for the current block based on the deformation.

According to another aspect of the present disclosure, there is provided a method of deformable block based motion compensation, the method comprising: receiving motion prediction information of a current block; receiving format information of a 360-degree video; and generating a prediction block for the current block by using the motion prediction information and the format information.

According to another aspect of the present disclosure, there is provided an apparatus for deformable block based motion compensation, the apparatus being configured to: detect format information of a 360-degree video; deform at least one of a form of a current block and a form of a neighbor block by using the format information; and predict a motion vector for the current block based on the deformation.

According to another aspect of the present disclosure, there is provided an apparatus for deformable block based motion compensation, the apparatus being configured to: receive motion prediction information of a current block; receive format information of a 360-degree video; and generate a prediction block for the current block by using the motion prediction information and the format information.

It is to be understood that the foregoing summarized features are exemplary aspects of the following detailed description of the present disclosure without limiting the scope of the present invention.

### Advantageous Effects

According to the present disclosure, a method and apparatus for deformable block based motion prediction for video encoding/decoding can be provided.

Also, according to the present disclosure, a method and apparatus for deformable block based motion compensation for video encoding/decoding can be provided.

Also, according to the present disclosure, a method and apparatus for performing deformable block based motion prediction in consideration of a video characteristic in 360-degree video encoding/decoding process can be provided.

Also, according to the present disclosure, a method and apparatus for performing deformable block based motion compensation in consideration of a video characteristic in 360-degree video encoding/decoding process can be provided.

Effects that may be obtained from the present disclosure will not be limited to only the above described effects. In addition, other effects which are not described herein will become apparent to those skilled in the art from the following description.

### DESCRIPTION OF DRAWINGS

FIG. 1 is a block diagram illustrating configurations of an encoding apparatus according to an embodiment of the present disclosure.

FIG. 2 is a block diagram illustrating configurations of a decoding apparatus according to an embodiment of the present disclosure.

FIG. 3 is a view schematically illustrating a partition structure of an image when encoding and decoding the image.

FIG. 4 is a view illustrating an embodiment of an intra-prediction process.

FIG. 5 is a view illustrating an embodiment of an inter-prediction process.

FIG. 6 is a view illustrating a process of transform and quantization.

FIG. 7 is a view schematically illustrating a partition structure of an image when encoding and decoding the image.

FIG. 8 is a view illustrating a 360-degree video photographing apparatus according to an embodiment of the present disclosure.

FIG. 9 is a view illustrating projection formats of a 360-degree video according to an embodiment of the present disclosure.

FIG. 10 is a view illustrating an ERP video according to an embodiment of the present disclosure.

FIG. 11 is a view illustrating ERP distortion according to an embodiment of the present disclosure.

FIG. 12 is a view illustrating an embodiment of a method of typical block based motion prediction.

FIG. 13 is a view illustrating a problem occurring when applying a technique of typical block based motion prediction to an ERP video according to an embodiment of the present disclosure.

FIG. 14 is a view illustrating a method of deformable block based motion prediction according to an embodiment of the present disclosure.

FIG. 15 is a view illustrating a method of deformable block based motion prediction according to another embodiment of the present disclosure.

FIG. 16 is a view illustrating a padding video for an ERP video according to an embodiment of the present disclosure.

FIG. 17 is a view illustrating a method of deformable block based motion prediction according to still another embodiment of the present disclosure.

FIG. 18 is a view illustrating how an apparatus for deformable block based motion prediction operates according to an embodiment of the present disclosure.

FIG. 19 is a view illustrating how an apparatus for deformable block based motion compensation operates according to an embodiment of the present disclosure.

### MODE FOR INVENTION

Hereinbelow, exemplary embodiments of the present disclosure will be described in detail such that the ordinarily skilled in the art would easily understand and implement an apparatus and a method provided by the present disclosure in conjunction with the accompanying drawings. However, the present disclosure may be embodied in various forms and the scope of the present disclosure should not be construed as being limited to the exemplary embodiments.

In describing embodiments of the present disclosure, well-known functions or constructions will not be described in detail when they may obscure the spirit of the present disclosure. Further, parts not related to description of the present disclosure are not shown in the drawings and like reference numerals are given to like components.

In the present disclosure, it will be understood that when an element is referred to as being “connected to”, “coupled to”, or “combined with” another element, it can be directly connected or coupled to or combined with the another element or intervening elements may be present therebetween. It will be further understood that the terms “comprises”, “includes”, “have”, etc. when used in the present disclosure specify the presence of stated features, integers, steps, operations, elements, components, and/or combinations thereof but do not preclude the presence or addition of one or more other features, integers, steps, operations, elements, components, and/or combinations thereof.

It will be understood that, although the terms “first”, “second”, etc. may be used herein to describe various elements, these elements should not be limited by these terms. These terms are only used to distinguish one element from another element and not used to show order or priority among elements. For instance, a first element discussed below could be termed a second element without departing from the teachings of the present disclosure. Similarly, the second element could also be termed as the first element.

In the present disclosure, distinguished elements are termed to clearly describe features of various elements and do not mean that the elements are physically separated from each other. That is, a plurality of distinguished elements may be combined into a single hardware unit or a single software unit, and conversely one element may be implemented by a plurality of hardware units or software units. Accordingly, although not specifically stated, an integrated form of various elements or separated forms of one element may fall within the scope of the present disclosure.

In the present disclosure, all of the constituent elements described in various embodiments should not be construed as being essential elements but some of the constituent elements may be optional elements. Accordingly, embodiments configured by respective subsets of constituent elements in a certain embodiment also may fall within the scope of the present disclosure. In addition, embodiments configured by adding one or more elements to various elements also may fall within the scope of the present disclosure.

Hereinafter, embodiments of the present invention will be described in detail with reference to the accompanying drawings.

In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

Hereinafter, an image may mean a picture configuring a video, or may mean the video itself. For example, “encoding or decoding or both of an image” may mean “encoding or decoding or both of a moving picture”, and may mean “encoding or decoding or both of one image among images of a moving picture.”

Hereinafter, terms “moving picture” and “video” may be used as the same meaning and be replaced with each other.

Hereinafter, a target image may be an encoding target image which is a target of encoding and/or a decoding target image which is a target of decoding. Also, a target image may be an input image inputted to an encoding apparatus, and an input image inputted to a decoding apparatus. Here, a target image may have the same meaning with the current image.

Hereinafter, terms “image”, “picture, “frame” and “screen” may be used as the same meaning and be replaced with each other.

Hereinafter, a target block may be an encoding target block which is a target of encoding and/or a decoding target block which is a target of decoding. Also, a target block may be the current block which is a target of current encoding and/or decoding. For example, terms “target block” and “current block” may be used as the same meaning and be replaced with each other.

Hereinafter, terms “block” and “unit” may be used as the same meaning and be replaced with each other. Or a “block” may represent a specific unit.

Hereinafter, terms “region” and “segment” may be replaced with each other.

Hereinafter, a specific signal may be a signal representing a specific block. For example, an original signal may be a signal representing a target block. A prediction signal may be a signal representing a prediction block. A residual signal may be a signal representing a residual block.

In embodiments, each of specific information, data, flag, index, element and attribute, etc. may have a value. A value of information, data, flag, index, element and attribute equal to “0” may represent a logical false or the first predefined value. In other words, a value “0”, a false, a logical false and the first predefined value may be replaced with each other. A value of information, data, flag, index, element and attribute equal to “1” may represent a logical true or the second predefined value. In other words, a value “1”, a true, a logical true and the second predefined value may be replaced with each other.

When a variable i or j is used for representing a column, a row or an index, a value of i may be an integer equal to or greater than 0, or equal to or greater than 1. That is, the column, the row, the index, etc. may be counted from 0 or may be counted from 1.

### Description of Terms

Encoder: means an apparatus performing encoding. That is, means an encoding apparatus.

Decoder: means an apparatus performing decoding. That is, means an decoding apparatus.

Block: is an M×N array of a sample. Herein, M and N may mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit constituting a block. It may be expressed as a value from 0 to 2Bd−1 according to a bit depth (Bd). In the present invention, the sample may be used as a meaning of a pixel. That is, a sample, a pel, a pixel may have the same meaning with each other.

Unit: may refer to an encoding and decoding unit. When encoding and decoding an image, the unit may be a region generated by partitioning a single image. In addition, the unit may mean a subdivided unit when a single image is partitioned into subdivided units during encoding or decoding. That is, an image may be partitioned into a plurality of units. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a square shape, a rectangular shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method and a binary-tree partitioning method to configure a lower unit such as coding unit, prediction unit, transform unit, etc. It may be used as a term for designating a sample block that becomes a process unit when encoding/decoding an image as an input image.

Coding Tree Block: may be used as a term for designating any one of a Y coding tree block, Cb coding tree block, and Cr coding tree block.

Neighbor Block: may mean a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: may mean a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at a corresponding position as the current block of the current picture within a reference image, or a neighbor block thereof.

Unit Depth: may mean a partitioned degree of a unit. In a tree structure, the highest node(Root Node) may correspond to the first unit which is not partitioned. Also, the highest node may have the least depth value. In this case, the highest node may have a depth of level 0. A node having a depth of level 1 may represent a unit generated by partitioning once the first unit. A node having a depth of level 2 may represent a unit generated by partitioning twice the first unit. A node having a depth of level n may represent a unit generated by partitioning n-times the first unit. A Leaf Node may be the lowest node and a node which cannot be partitioned further. A depth of a Leaf Node may be the maximum level. For example, a predefined value of the maximum level may be 3. A depth of a root node may be the lowest and a depth of a leaf node may be the deepest. In addition, when a unit is expressed as a tree structure, a level in which a unit is present may mean a unit depth.

Bitstream: may mean a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, and tile header information.

Parsing: may mean determination of a value of a syntax element by performing entropy decoding, or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Mode: may be information indicating a mode encoded/decoded with intra prediction or a mode encoded/decoded with inter prediction. Prediction Unit: may mean a basic unit when performing prediction such as inter-prediction, intra-prediction, inter-compensation, intra-compensation, and motion compensation. A single prediction unit may be partitioned into a plurality of partitions having a smaller size, or may be partitioned into a plurality of lower prediction units. A plurality of partitions may be a basic unit in performing prediction or compensation. A partition which is generated by dividing a prediction unit may also be a prediction unit.

Prediction Unit Partition: may mean a form obtained by partitioning a prediction unit.

Reference picture list: may mean a list including at least one reference picture that is used for inter prediction or motion compensation. Types of the reference picture list may be List Combined (LC), List 0 (L0), List 1 (L1), List 2 (L2), List 3 (L3), etc. At least one reference picture list may be used for inter prediction.

Inter-prediction indicator: may mean an inter-prediction direction (uni-directional prediction, bi-directional prediction, etc.) of the current block. Alternatively, it may mean the number of reference pictures used for generating a prediction block of the current block. Alternatively, it may mean the number of prediction blocks used for performing inter prediction or motion compensation on the current block.

Prediction list utilization flag: indicates whether to generate a prediction block using at least one reference picture in a specific reference picture list. The inter-prediction indicator may be derived using the prediction list utilization flag, and reversely, the prediction list utilization flag may be derived using the inter-prediction indicator. For example, when the prediction list utilization flag indicates a first value of 0, it may indicate that the prediction block is not generated using the reference picture in the reference picture list. When the prediction list utilization flag indicates a second value of 1, it may indicate that the prediction block is generated using the reference picture list.

Reference picture index: may mean an index of a specific reference picture in the reference picture list.

Reference picture: may mean a picture to which a specific block refers for inter prediction or motion compensation. Alternatively, the reference picture may be a picture containing a reference block to which the current block refers for inter prediction or motion compensation. Hereinafter, terms “reference picture” and “reference image” may be used in the same meaning, and may be used interchangeably.

Motion vector: may be a two-dimensional vector used for inter prediction or motion compensation. The motion vector may mean an offset between an encoding/decoding target block and the reference block. For example, (mvX, mvY) may indicate the motion vector. mvX may indicate a horizontal component, and mvY may indicate a vertical component.

Search range: may be a two-dimensional region in which searching for the motion vector is performed during inter prediction. For example, the size of the search range may be M×N. M and N may be positive integers. Also, for example, the shapes of the search range may include a geometric figure expressed in two dimensions, such as a square, a rectangle, a trapezoid, a triangle, a pentagon, etc.

Motion vector candidate: may mean a block that is a prediction candidate or may mean a motion vector of the block when prediction the motion vector. Also, the motion vector candidate may be included in a motion vector candidate list.

Motion vector candidate list: may mean a list configured using at least one motion vector candidate.

Motion vector candidate index: may mean an indicator that indicates the motion vector candidate in the motion vector candidate list. The motion vector candidate index may be an index of a motion vector predictor.

Motion information: may mean the motion vector, the reference picture index, and the inter-prediction indicator as well as information including at least one of the prediction list utilization flag, reference picture list information, the reference picture, the motion vector candidate, the motion vector candidate index, the merge candidate, the merge index, etc.

Merge candidate list: may mean a list configured using at least one merge candidate. Merge candidate: may mean a spatial merge candidate, a temporal merge candidate, a combined merge candidate, a combined bi-prediction merge candidate, a zero merge candidate, etc. The merge candidate may include motion information such as the inter-prediction indicator, the reference picture index for each list, the motion vector, the prediction list utilization flag, etc.

Merge index: may mean an indicator that indicates the merge candidate in the candidate list. Also, the merge index may indicate a block, which derives the merge candidate, among reconstructed blocks spatially/temporally adjacent to the current block. Also, the merge index may indicate at least one of pieces of motion information of the merge candidate.

Transform Unit: may mean a basic unit when performing encoding/decoding such as transform, inverse-transform, quantization, dequantization, transform coefficient encoding/decoding of a residual signal. A single transform unit may be partitioned into a plurality of lower-level transform units having a smaller size. Here, transformation/inverse-transformation may comprise at least one among the first transformation/the first inverse-transformation and the second transformation/the second inverse-transformation.

Scaling: may mean a process of multiplying a transform coefficient level by a factor. A transform coefficient may be generated by scaling a transform coefficient level. The scaling also may be referred to as dequantization.

Quantization Parameter: may mean a value used when generating a transform coefficient level of a transform coefficient during quantization. The quantization parameter also may mean a value used when generating a transform coefficient by scaling a transform coefficient level during dequantization. The quantization parameter may be a value mapped on a quantization step size.

Delta Quantization Parameter: may mean a difference value between a predicted quantization parameter and a quantization parameter of an encoding/decoding target unit.

Scan: may mean a method of sequencing coefficients within a unit, a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform Coefficient: may mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: may mean a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: may mean a transform coefficient having a value other than zero, or a transform coefficient level having a value other than zero.

Quantization Matrix: may mean a matrix used in a quantization process or a dequantization process performed to improve subjective or objective image quality. The quantization matrix also may be referred to as a scaling list.

Quantization Matrix Coefficient: may mean each element within a quantization matrix. The quantization matrix coefficient also may be referred to as a matrix coefficient.

Default Matrix: may mean a predetermined quantization matrix preliminarily defined in an encoder or a decoder.

Non-default Matrix: may mean a quantization matrix that is not preliminarily defined in an encoder or a decoder but is signaled by a user.

Statistic Value: a statistic value for at least one among a variable, an encoding parameter, a constant value, etc. which have a computable specific value may be one or more among an average value, a weighted average value, a weighted sum value, the minimum value, the maximum value, the most frequent value, a median value, an interpolated value of the corresponding specific values.

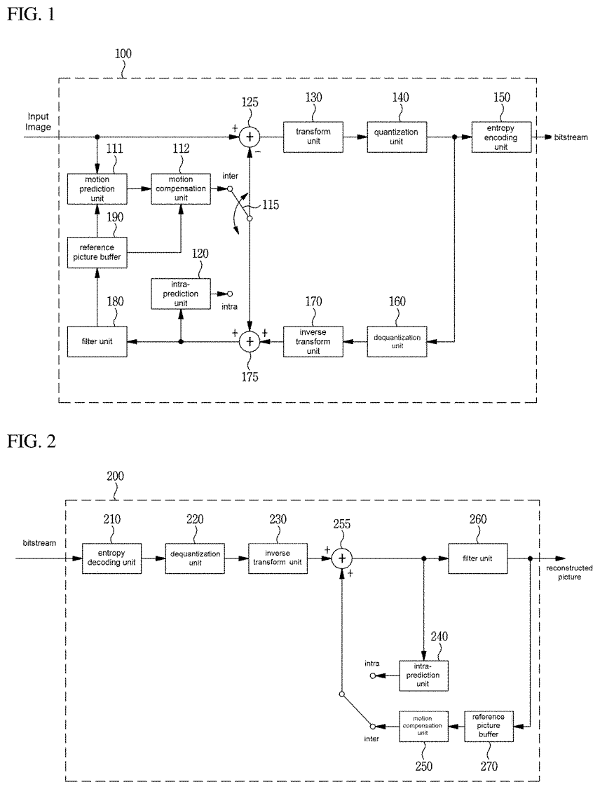

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, a inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream including encoded information through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual block using a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a sample of a block that has been already encoded/decoded and is adjacent to a current block as a reference sample. The intra-prediction unit 120 may perform spatial prediction for the current block by using a reference sample, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 112 may generate a prediction block by performing motion compensation for the current block using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a residual of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of sample information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level, the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block partition structure, whether to partition of a quad-tree form, whether to partition of a binary-tree form, a partition direction of a binary-tree form (horizontal direction or vertical direction), a partition form of a binary-tree form (symmetric partition or asymmetric partition), a prediction mode(intra prediction or inter prediction), an intra-prediction mode/direction, a reference sample filtering method, a reference sample filter tab, a reference sample filter coefficient, a prediction block filtering method, a prediction block filter tap, a prediction block filter coefficient, a prediction block boundary filtering method, a prediction block boundary filter tab, a prediction block boundary filter coefficient, an inter-prediction mode, motion information, a motion vector, a reference picture index, a inter-prediction angle, an inter-prediction indicator, a prediction list utilization flag, a reference picture list, a reference picture, a motion vector predictor candidate, a motion vector candidate list, whether to use a merge mode, a merge candidate, a merge candidate list, whether to use a skip mode, an interpolation filter type, an interpolation filter tab, an interpolation filter coefficient, a motion vector size, a presentation accuracy of a motion vector, a transform type, a transform size, information of whether or not a primary(first) transform is used, information of whether or not a secondary transform is used, a primary transform index, a secondary transform index, information of whether or not a residual signal is present, a coded block pattern, a coded block flag(CBF), a quantization parameter, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample offset category, an adaptive sample offset type, whether to apply an adaptive loop filter, an adaptive loop filter coefficient, an adaptive loop filter tab, an adaptive loop filter shape/form, a binarization/inverse-binarization method, a context model determining method, a context model updating method, whether to perform a regular mode, whether to perform a bypass mode, a context bin, a bypass bin, a transform coefficient, a transform coefficient level, a quantized level, a transform coefficient level scanning method, an image displaying/outputting sequence, slice identification information, a slice type, slice partition information, tile identification information, a tile type, tile partition information, a picture type, a bit depth, and information on a luma signal or information on a chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image in reference picture buffer 190.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAO), and an adaptive loop filter (ALF) to a reconstructed sample, a reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based samples included in several rows or columns which are included in the block. When a deblocking filter is applied to a block, another filter may be applied according to a required deblocking filtering strength.

In order to compensate an encoding error, a proper offset value may be added to a sample value by using a sample adaptive offset. The sample adaptive offset may correct an offset of a deblocked image from an original image by a sample unit. A method of partitioning samples of an image into a predetermined number of regions, determining a region to which an offset is applied, and applying the offset to the determined region, or a method of applying an offset in consideration of edge information on each sample may be used.

The adaptive loop filter may perform filtering based on a comparison result of the filtered reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190. A reconstructed block processed by the filter unit 180 may be a part of a reference image. That is, a reference image is a reconstructed image composed of reconstructed blocks processed by the filter unit 180. The stored reference image may be used later in inter prediction or motion compensation.

FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, a inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be a inverse-process of the entropy encoding method described above.

In order to decode a transform coefficient level, the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing, for the current block, spatial prediction that uses a sample value of a block adjacent to a decoding target block and which has been already decoded.

When an inter mode is used, the motion compensation unit 250 may generate a prediction block by performing, for the current block, motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction. A reconstructed block processed by the filter unit 260 may be a part of a reference image. That is, a reference image is a reconstructed image composed of reconstructed blocks processed by the filter unit 260. The stored reference image may be used later in inter prediction or motion compensation.

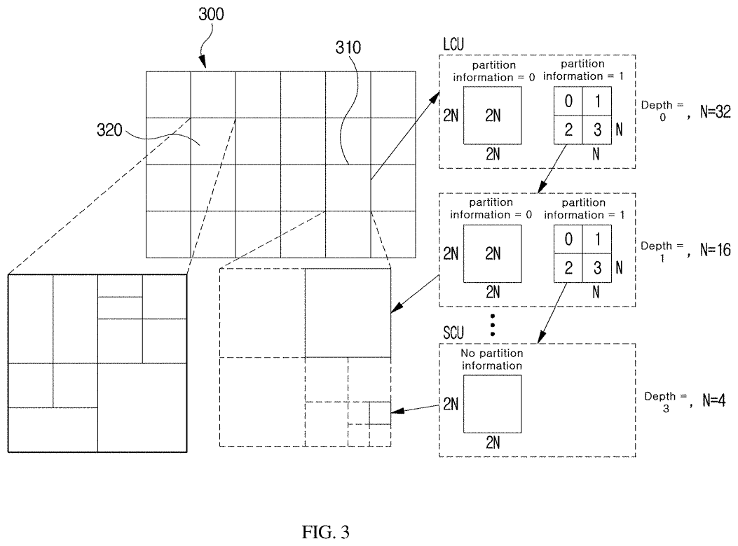

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra prediction mode and an inter prediction mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit may be partitioned into a plurality of lower level units hierarchically associated with depth information based on a tree structure. In other words, a unit and a lower level unit generated by partitioning the unit may correspond to a node and a child node of the node, respectively. Each of partitioned lower unit may have depth information. Depth information may be information representing a size of a CU, and may be stored in each CU. Unit depth represents times and/or degrees related to partitioning a unit. Therefore, partitioning information of a lower-level unit may comprise information on a size of the lower-level unit.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. By the recursive partitioning, at least one among a height and a width of a CU after partitioning may decrease comparing with at least one among a height and a width of a CU before partitioning. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning. For example, for each depth, a CU which is not partitioned may have a size of 2N×2N. Also, in case of a CU which is partitioned, a CU with a size of 2N×2N may be partitioned into four CUs with a size of N×N. A size of N may decrease to half as a depth increase by 1.

In addition, information whether or not the CU is partitioned may be represented by using partition information of the CU. The partition information may be 1-bit information. All CUs, except for a SCU, may include partition information. For example, when a value of partition information is 1, the CU may not be partitioned, when a value of partition information is 2, the CU may be partitioned.

Referring to FIG. 3, an LCU having a depth 0 may be a 64×64 block. 0 may be a minimum depth. A SCU having a depth 3 may be an 8×8 block. 3 may be a maximum depth. A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit may be partitioned into a quad-tree form.

For example, when a single coding unit is partitioned into two coding units, a horizontal or vertical size of the two coding units may be a half of a horizontal or vertical size of the coding unit before being partitioned. For example, when a coding unit having a 32×32 size is partitioned in a vertical direction, each of two partitioned coding units may have a size of 16×32. When a single coding unit is partitioned into two coding units, it may be called that the coding unit is partitioned in a binary-tree form. An LCU 320 of FIG. 3 is an example of an LCU to which both of partitioning of a quad-tree form and partitioning of a binary-tree form are applied.

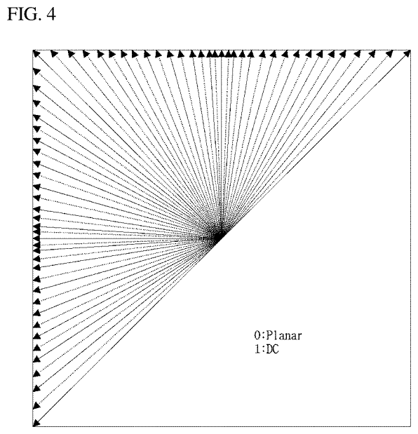

FIG. 4 is a view showing an intra-prediction process.

Arrows from center to outside in FIG. 4 may represent prediction directions of intra prediction modes.

Intra encoding and/or decoding may be performed by using a reference sample of a neighbor block of the current block. A neighbor block may be a reconstructed neighbor block. For example, intra encoding and/or decoding may be performed by using an encoding parameter or a value of a reference sample included in a reconstructed neighbor block.

A prediction block may mean a block generated by performing intra prediction. A prediction block may correspond to at least one among CU, PU and TU. A unit of a prediction block may have a size of one among CU, PU and TU. A prediction block may be a square block having a size of 2×2, 4×4, 16×16, 32×32 or 64×64 etc. or may be a rectangular block having a size of 2×8, 4×8, 2×16, 4×16 and 8×16 etc.

Intra prediction may be performed according to intra prediction mode for the current block. The number of intra prediction modes which the current block may have may be a fixed value and may be a value determined differently according to an attribute of a prediction block. For example, an attribute of a prediction block may comprise a size of a prediction block and a shape of a prediction block, etc.

The number of intra-prediction modes may be fixed to N regardless of a block size. Or, the number of intra prediction modes may be 3, 5, 9, 17, 34, 35, 36, 65, or 67 etc. Alternatively, the number of intra-prediction modes may vary according to a block size or a color component type or both. For example, the number of intra prediction modes may vary according to whether the color component is a luma signal or a chroma signal. For example, as a block size becomes large, a number of intra-prediction modes may increase. Alternatively, a number of intra-prediction modes of a luma component block may be larger than a number of intra-prediction modes of a chroma component block.

An intra-prediction mode may be a non-angular mode or an angular mode. The non-angular mode may be a DC mode or a planar mode, and the angular mode may be a prediction mode having a specific direction or angle. The intra-prediction mode may be expressed by at least one of a mode number, a mode value, a mode numeral, a mode angle, and mode direction. A number of intra-prediction modes may be M including 1, and the non-angular and the angular mode.

In order to intra-predict a current block, a step of determining whether or not samples included in a reconstructed neighbor block may be used as reference samples of the current block may be performed. When a sample that is not usable as a reference sample of the current block is present, a value obtained by duplicating or performing interpolation on at least one sample value among samples included in the reconstructed neighbor block or both may be used to replace with a non-usable sample value of a sample, thus the replaced sample value is used as a reference sample of the current block.

When intra-predicting, a filter may be applied to at least one of a reference sample and a prediction sample based on an intra-prediction mode and a current block size.

In case of a planar mode, when generating a prediction block of a current block, according to a position of a prediction target sample within a prediction block, a sample value of the prediction target sample may be generated by using a weighted sum of an upper and left side reference sample of a current sample, and a right upper side and left lower side reference sample of the current block. In addition, in case of a DC mode, when generating a prediction block of a current block, an average value of upper side and left side reference samples of the current block may be used. In addition, in case of an angular mode, a prediction block may be generated by using an upper side, a left side, a right upper side, and/or a left lower side reference sample of the current block. In order to generate a prediction sample value, interpolation of a real number unit may be performed.

An intra-prediction mode of a current block may be entropy encoded/decoded by predicting an intra-prediction mode of a block present adjacent to the current block. When intra-prediction modes of the current block and the neighbor block are identical, information that the intra-prediction modes of the current block and the neighbor block are identical may be signaled by using predetermined flag information. In addition, indicator information of an intra-prediction mode that is identical to the intra-prediction mode of the current block among intra-prediction modes of a plurality of neighbor blocks may be signaled. When intra-prediction modes of the current block and the neighbor block are different, intra-prediction mode information of the current block may be entropy encoded/decoded by performing entropy encoding/decoding based on the intra-prediction mode of the neighbor block.

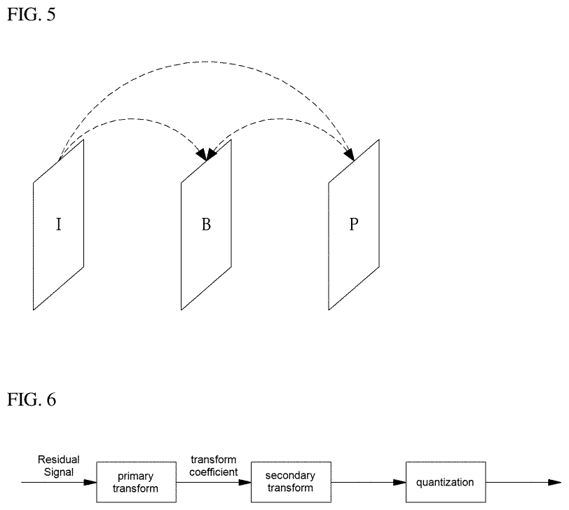

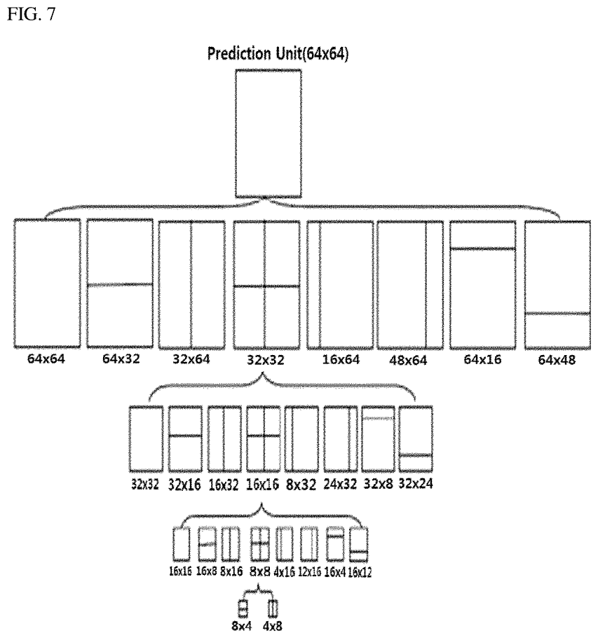

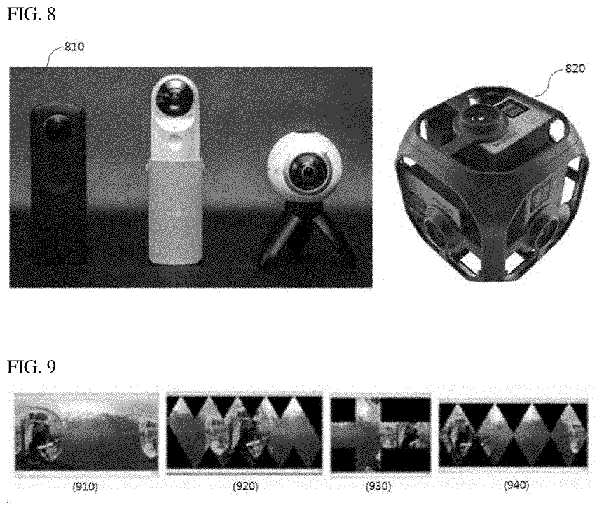

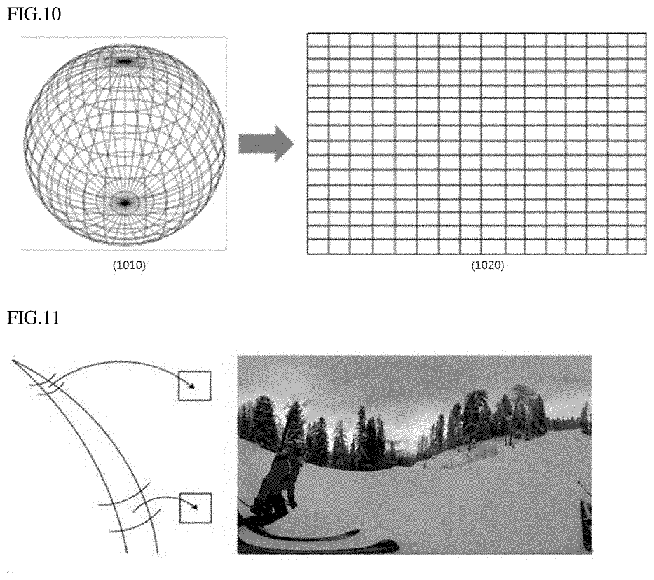

FIG. 5 is a view illustrating an embodiment of an inter-prediction process.

The quadrangles shown in FIG. 5 may indicate an image. Also, the arrows in FIG. 5 may indicate prediction directions. Images may be classified into an I picture (intra picture), a P picture (predictive picture), a B picture (bi-predictive picture), etc. according to encoding type.

The I picture may be encoded/decoded through intra prediction without inter prediction. The P picture may be encoded/decoded through inter prediction using only the reference picture which is present in a unit-direction (e.g., forward direction or backward direction). The B picture may be encoded/decoded through inter prediction using the reference pictures which are present in bi-directions (e.g., forward direction and backward direction). Also, the B picture may be encoded/decoded through inter prediction using the reference pictures present in bi-directions or through inter prediction using the reference picture present in one direction of the forward direction and backward direction. Here, the bi-directions may be the forward direction and the backward direction. Here, when inter prediction is used, the encoder may perform inter prediction or motion compensation, and the decoder may perform motion compensation corresponding thereto.

Hereinbelow, inter prediction according to the embodiment will be described in detail.

Inter prediction or motion compensation may be performed using the reference picture and the motion information.

The motion information on the current block may be derived by the encoding apparatus 100 and the decoding apparatus 200 during inter prediction. The motion information may be derived using motion information of the reconstructed neighbor block, motion information of a collocated block (col block), and/or a block adjacent to the col block. The col block may be a block corresponding to a spatial position of the current block in a collocated picture (col picture) which is already reconstructed. Here, the col picture may be one picture of at least one reference picture included in the reference picture list.

A method of deriving the motion information may vary according to a prediction mode of the current block. For example, as prediction modes being applied for inter prediction, there are an AMVP mode, a merge mode, a skip mode, a current picture reference mode, etc. Here, the merge mode may be referred to as a motion merge mode.

For example, as the prediction mode, when the AMVP mode applies, at least one of the motion vector of the reconstructed neighbor block, the motion vector of the col block, the motion vector of the block adjacent to the col block, and the (0, 0) motion vector may be determined as the motion vector candidate to generate the motion vector candidate list. The generated motion vector candidate list may be used to derive the motion vector candidate. Based on the derived motion vector candidate, the motion information of the current block may be determined. Here, the motion vector of the col block or the motion vector of the block adjacent to the col block may be referred to as a temporal motion vector candidate. The motion vector of the reconstructed neighbor block may be referred to as a spatial motion vector candidate.

The encoding apparatus 100 may calculate a motion vector difference (MVD) between the motion vector of the current block and the motion vector candidate, and may entropy encode the MVD. Also, the encoding apparatus 100 may entropy encode the motion vector candidate index to generate a bitstream. The motion vector candidate index may indicate an optimum motion vector candidate selected from motion vector candidates included in the motion vector candidate list. The decoding apparatus 200 may entropy decode the motion vector candidate index from the bitstream, and may select a motion vector candidate of a decoding target block among the motion vector candidates included in the motion vector candidate list by using the entropy decoded motion vector candidate index. Also, the decoding apparatus 200 may derive a motion vector of the decoding target block through a sum of the entropy decoded MVD and the motion vector candidate.

The bitstream may include the reference picture index indicating the reference picture, etc. The reference picture index may be entropy encoded and signaled from the encoding apparatus 100 to the decoding apparatus 200 via the bitstream. The decoding apparatus 200 may generate a prediction block of the decoding target block on the basis of the derived motion vector and reference picture index information.

As another method of deriving the motion information, a merge mode is used. The merge mode may mean a merger of motions of multiple blocks. The merge mode may mean a mode in which the motion information of the current block is derived from the motion information of the neighbor block. When applying the merge mode, the motion information of the reconstructed neighbor block and/or the motion information of the col block may be used to generate a merge candidate list. The motion information may include at least one of 1) the motion vector, 2) the reference picture index, and 3) the inter-prediction indicator. A prediction indicator may indicate a uni-direction (L0 prediction, L1 prediction) or bi-directions.

The merge candidate list may indicate a list storing motion information. The motion information stored in the merge candidate list may be at least one of motion information (spatial merge candidate) of the neighbor block adjacent to the current block, motion information (temporal merge candidate) of the collocated block corresponding to the current block in the reference picture, motion information newly generated by a combination of motion information already present in the merge candidate list, and the zero merge candidate.

The encoding apparatus 100 may entropy encode at least one of a merge flag and a merge index to generate a bitstream, and may signal the bitstream to the decoding apparatus 200. The merge flag may be information indicating whether to perform merge mode on each block, and the merge index may be information on which block of neighbor blocks adjacent to the current block to merge with. For example, neighbor blocks of the current block may include at least one of a left neighbor block, a top neighbor block, and a temporal neighbor block of the current block.

The skip mode may be a mode in which motion information of the neighbor block itself is applied to the current block. When the skip mode is used, the encoding apparatus 100 may entropy encode information on motion information of which block is to be used as motion information of the current block, and may signal the information to the decoding apparatus 200 via a bitstream. Here, the encoding apparatus 100 may not signal a syntax element related to at least one of motion vector difference information, a coded block flag, and a transform coefficient level to the decoding apparatus 200.

The current picture reference mode may mean a prediction mode using a pre-reconstructed region within the current block to which the current block belongs. Here, in order to specify the pre-reconstructed region, a vector may be defined. Whether the current block is encoded in the current picture reference mode may be encoded using the reference picture index of the current block. A flag or an index indicating whether the current block is a block encoded in the current picture reference mode may be signaled, or may be derived using the reference picture index of the current block. When the current block is encoded in the current picture reference mode, the current picture may added to a fixed position or an arbitrary position within the reference picture list for the current block. The fixed position may be, for example, a position where the reference picture index is zero or the last position. When the current picture is added to an arbitrary position within the reference picture list, an individual reference picture index indicating the arbitrary position may be signaled.

FIG. 6 is a view illustrating a process of transform and quantization.

As shown in FIG. 6, transform and/or quantization is performed on a residual signal such that a quantized level is generated. The residual signal may be generated by a difference between the original block and the prediction block (intra-prediction block or inter-prediction block). Here, the prediction block may be a block generated by intra prediction or inter prediction. Here, transform may include at least one of primary transform and secondary transform. Primary transform is performed on the residual signal such that a transform coefficient may be generated. Secondary transform is performed on the transform coefficient such that a secondary transform coefficient may be generated.

Primary transform may be performed using at least one of multiple pre-defined transform methods. For example, the multiple pre-defined transform methods may include discrete cosine transform (DCT), discrete sine transform (DST), Karhunen-Loève transform (KLT), etc. On the transform coefficient generated after performing primary transform, secondary transform may be performed. A transform method applied in primary transform and/or secondary transform may be determined depending on at least one of encoding parameters of the current block and/or the neighbor block. Alternatively, transform information indicating the transform method may be signaled.

Quantization is performed on the result of performing primary transform and/or secondary transform or on the residual signal such that a quantized level may be generated. On the basis of at least one of the intra-prediction mode or the block size/shape, the quantized level may be scanned according to at least one of up-right diagonal direction scanning, vertical direction scanning, and horizontal direction scanning. For example, the coefficient of the block is scanned using up-right diagonal direction scanning such that it may be changed in a one-dimensional vector form. Depending on the size of the transform block and/or intra-prediction mode, instead of up-right diagonal direction scanning, it is possible to use vertical direction scanning for scanning the two-dimensional block form coefficient in a column direction, and horizontal direction scanning for scanning the two-dimensional block form coefficient in a row direction. The scanned quantization level may be entropy encoded and included in the bitstream.

The decoder may entropy decode the bitstream such that the quantized level may be generated. The quantized level is inversely scanned, and may be provided in two-dimensional block form. Here, as a method of inverse scanning, at least one of up-right diagonal direction scanning, vertical direction scanning, and horizontal direction scanning may be performed.

Dequantization may be performed on the quantized level, secondary inverse transform may be performed depending on whether secondary inverse transform is performed, and primary inverse transform may be performed on the resulting of performing secondary inverse transform depending on whether primary inverse transform is performed, whereby the reconstructed residual signal may be generated.

FIG. 12 is a view illustrating an embodiment of a method of typical block based motion prediction. For example, a method of block based motion prediction may be a block matching algorithm (BA). Referring to FIG. 12, in order to find a motion vector for a current block 1212 of a current frame 1210 in an image sequence, a specific search region 1222 is set in a target frame 1220. Next, based on the search region 1222, a block having the smallest difference from the current block 1212 is found. The motion path from a block (best match block) 1224 which is determined from the search result to the current block 1212 may be set as the motion vector 1230.

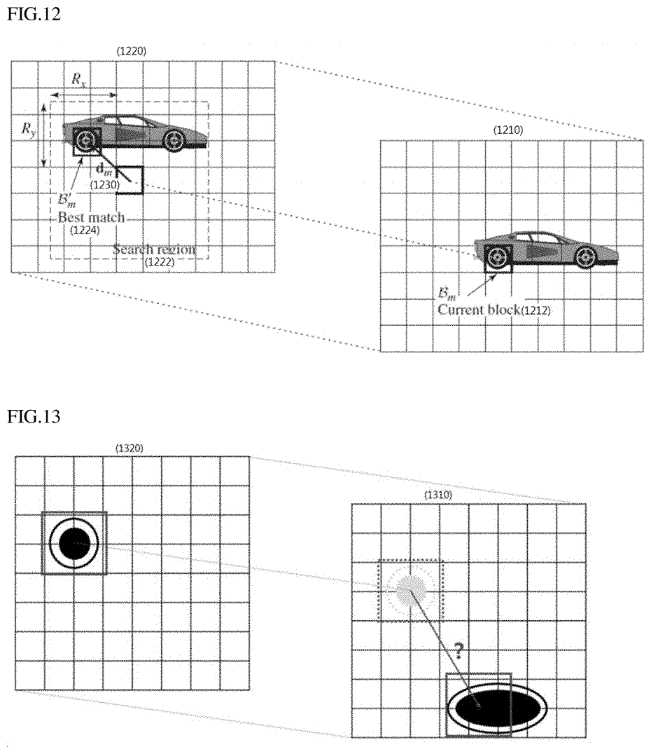

In the meantime, as shown in FIG. 11, moving up and down in the ERP video with respect to the equator may cause distortion in which the video is stretched left and right by 1/cos φ. Thus, in order to apply a technique of typical block based motion estimation described in FIG. 12 to the ERP video, a technology of compensating for distortion where the video is stretched is required. FIG. 13 is a view illustrating a problem occurring when applying a technique of typical block based motion prediction to an ERP video according to an embodiment of the present disclosure. Referring to FIG. 13, since the original video is deformed when moving coordinates in a particular direction in the ERP video, problems may occur, such as how to set the current block of a current frame 1310, how to set a search region in a target frame 1320, how to set a form of a reference block of the target frame 1320, how to find a motion vector, how to process a method of generating a prediction block using a motion vector, etc.

Accordingly, according to the present disclosure, the method and apparatus for deformable block based motion prediction of may provide a way of determining a range of matching the current block with the neighbor block, a way of transforming the current block or the reference block by detecting that the determined range changes according to the 360-degree video characteristic, a way of matching the transformed current block with the neighbor block, etc. In the meantime, the “determined range” may be modified to “a position in a current frame of a block”.

Also, according to the present disclosure, the method and apparatus for deformable block based motion prediction may provide a process of detecting change according to the 360-degree video characteristic using the motion information of the neighbor block and deriving the block size designated by the motion information or a process of transforming the derived block into the form of the current block by detecting the 360-degree video characteristic in predicting the current block by using the motion information of the neighbor block.

Also, according to the present disclosure, the method and apparatus for deformable block based motion prediction may provide a process of detecting change according to the 360-degree video characteristic and deriving, by using one directional motion information of the current block and the position of the current block, the other directional motion information in predicting bi-directional motion information of the current block.

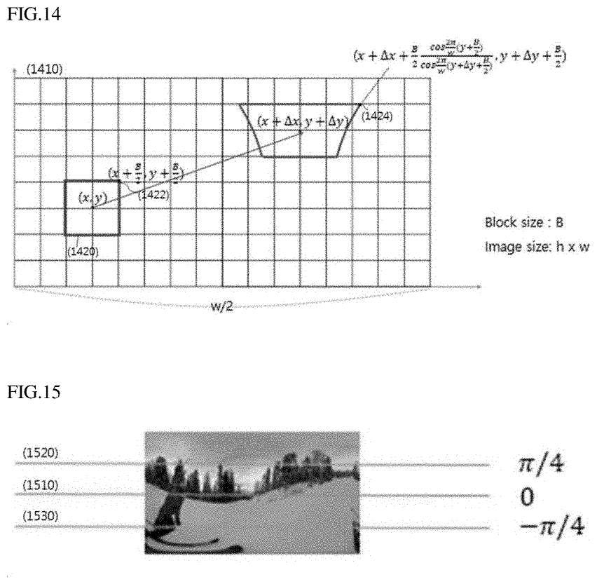

FIG. 14 is a view illustrating a method of deformable block based motion prediction according to an embodiment of the present disclosure.

Referring to FIG. 14, according to the present disclosure, the apparatus for deformable block based motion prediction may perform a deformable block matching algorithm based on a sample position in the video. In the apparatus for deformable block based motion prediction, for a current block 1420 in which coordinates of the center sample are (x, y) and the block size is B×B in a current frame 1410, the search region is set on the target frame (not shown) and a block having the smallest difference from the current block 1420 is found (motion search) based on the set search region. Through the above process, the apparatus for deformable block based motion prediction may obtain a motion vector (Δx, Δy). Also, the apparatus for deformable block based motion prediction may change the positions of the samples contained in the current block in consideration of the ERP video characteristic in which the video is distorted when moving coordinates in a particular direction. For example, the sample position may be changed from a first sample 1422 of coordinates

$$( x + \frac{B}{2} , y + \frac{B}{2} )$$

to a first sample 1424 of coordinates

$$( x + Δ x + \frac{B}{2} \frac{cos \frac{2 π}{w} ( y + \frac{B}{2} )}{cos \frac{2 π}{w} ( y + Δ y + \frac{B}{2} )} , y + Δ y + \frac{B}{2} )$$

by applying an ERP characteristic in which when moving up and down with respect to the equator may cause the video stretched left and right by

$$\frac{1}{cos ϕ} .$$

The first sample may be a sample positioned in the current block or at the boundary of the current block, but without being limited thereto, may be a sample in a block temporally or spatially adjacent to the current block.

According to the present disclosure, the apparatus for deformable block based motion prediction may change the form of the block on the basis of moving of the coordinates of a particular sample for each block of the current frame or the target frame. For example, based on moving of the coordinates of the center sample of each block, the form of the block may be changed. For example, the form of the block may include the size or shape of the block.

Also, according to the present disclosure, the apparatus for deformable block based motion prediction may consider the ERP video characteristic in which the y coordinate rapidly changes when it is close to the polar direction and slowly changes in the equator direction. For example, the apparatus for deformable block based motion prediction may determine whether to keep the form of the block in the conventional quadrangular form or to change the form of the block by comparing the size of the latitude in the ERP video with a preset threshold value. FIG. 15 is a view illustrating a method of deformable block based motion prediction according to another embodiment of the present disclosure. Referring to FIG. 15, with respect to the equator (latitude of 0 degree) 1510, in block prediction, a conventional method of block based motion prediction is used for a region between a first latitude 1520 and a second latitude 1530. For other regions, the method of deformable block based motion prediction described in FIG. 14 may be used. For example, the first latitude 1520 may be (π/4) and the second latitude 1530 may be −(π/4).

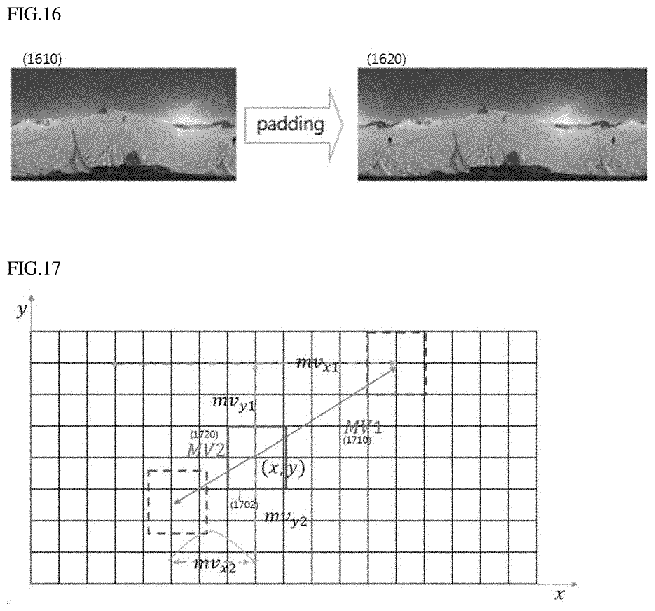

According to the present disclosure, the apparatus for deformable block based motion prediction may perform sample padding according to the sample position in the image. According to the method of deformable block based motion prediction described in FIG. 14, when the y coordinate is large, the degree to which the block increases is large. Therefore, padding may be required at the edge of the image. Due to the characteristic of the ERP video, since the right and left sides of the image are connected, the left or right image may be used in padding. FIG. 16 is a view illustrating a padding video for an ERP video according to an embodiment of the present disclosure. Referring to FIG. 16, the padding video 1620 may be obtained by padding particular left and right regions in the original ERP video 1610. For example, in the original ERP video, when the block size is B, the search region is R, the width of the video is W, and the height of the video is H, the padding video may be obtained by padding the left and right by

$$\frac{B}{2} \times \frac{w}{sin ( R \frac{2 π}{w} )}$$

respectively.

According to the present disclosure, the apparatus for deformable block based motion prediction may deform the form of the search region for finding the motion vector. For example, the form of the search region may include the size or shape of the search region. The search region for the motion vector may vary adaptively according to the size of the x or y component of the center coordinates of the block. For example, when the search region for the block near the equator is R×R, the search region may be chanted to R 1/cos φ×R 1/cos φ when moving in the polar direction.

According to the present disclosure, the apparatus for deformable block based motion prediction may provide a process of detecting change according to the 360-degree video characteristic and deriving, by using one directional motion information of the current block and the position of the current block, the other directional motion information in predicting bi-directional motion information of the current block. For example, according to the present disclosure, the apparatus for deformable block based motion prediction may perform a technique of asymmetric bi-directional motion vector scaling. In the 360-degree video, when the current block has a bi-directional motion vector and when a first motion vector mv1 in one direction is determined, a second motion vector mv2 in the other direction may be predicted. For example, in the apparatus for deformable block based motion prediction, the determined first motion vector and the x or y coordinate in the frame to which the current block belongs are used, and the x or y component of the first motion vector is multiplied by a scaling factor which is an integer, thereby obtaining the second motion vector. That is, the second motion vector is a vector different in size from the first motion vector. When the first motion vector mv1 is (Δx, Δy), the second motion vector mv2 may be expressed as (f1*(−Δx), f2*(−Δy)). Scaling factors f1 and f2 may be derived using the following Formula 2. FIG. 17 is a view illustrating a method of deformable block based motion prediction according to still another embodiment of the present disclosure. Referring to FIG. 17, when a front motion vector and a back motion vector with respect to the current block 1702 are a first motion vector mv1 1710 and a second motion vector mv2 1720 respectively, the second motion vector for the sample (x, y) of the current block may be derived by Formulas 1 and 2.

$$\begin{matrix}{mv}_{x 1} \text{:} {mv}_{y 1} = {mv}_{x 2} \text{:} {mv}_{y 2} & [ Formula ] \\ min Σ \text{?} Σ \text{?} ( \begin{matrix}{f}_{1} ( x \text{?} + mv \text{?} , {y}_{j} + mv \text{?} ) - \\ {f}_{2} ( x \text{?} + mv \text{?} , {y}_{j} + mv \text{?} \text{?} )\end{matrix} ) \text{?} , \\ if ( cos \frac{\text{?}}{\text{?}} ( {y}_{j} + mv \text{?} ) > cos \frac{\text{?}}{\text{?}} ( \text{?} ) ) \\ min Σ \text{?} Σ \text{?} ( \begin{matrix}{f}_{2} ( x \text{?} + mv \text{?} , {y}_{j} + mv \text{?} ) - \\ {f}_{1} ( x \text{?} + mv \text{?} , {y}_{j} + mv \text{?} \text{?} )\end{matrix} ) \text{?} , \\ if ( cos \frac{\text{?}}{\text{?}} ( {y}_{j} + mv \text{?} ) < cos \frac{\text{?}}{\text{?}} ( \text{?} ) ) \\ min Σ \text{?} Σ \text{?} ( \begin{matrix}{f}_{1} ( x \text{?} + mv \text{?} , {y}_{j} ) - \\ {f}_{2} ( x \text{?} + mv \text{?} , {y}_{j} )\end{matrix} ) \text{?} , \\ else ( cos \frac{\text{?}}{\text{?}} ( {y}_{j} + mv \text{?} ) = cos \frac{\text{?}}{\text{?}} ( \text{?} ) ) & [ Formula 2 ] \\ \text{?} \text{indicates text missing or illegible when filed} & \end{matrix}$$

Referring to Formula 1, the second motion vector mv2 may be obtained by multiplying the first motion vector mv1 by the scaling factor. Also, Formula 2 is a way of determining one of various scaling factors that may be selected. For example, in Formula 2, the scaling factor may be determined to minimize the different between the block f2 indicated by the second motion vector mv2 and the block f1 indicated by the first motion vector mv1. B is the block size.

The apparatus for deformable block based motion prediction according to the present disclosure may apply to a conventional compression codec technique. When applying a technique of conventional quadrangular block based motion prediction in order to encode a 360-degree ERP video, the apparatus for deformable block based motion prediction may adaptively turn on/off a particular type of a block according to the y coordinate of the block in the ERP video. For example, the apparatus for deformable block based motion prediction may use an asymmetric partition structure block partitioned in 2N×N or horizontal direction at the coordinates of the polar region. Also, the apparatus for deformable block based motion prediction may not use the asymmetric partition structure block partitioned in N×2N or vertical direction at the coordinates of the polar region.

Also, the apparatus for deformable block based motion prediction may use the block width by being approximated by the multiplier of 2 when deforming the block size according to the y coordinate in the ERP video. It is considered that the block size used in motion prediction of conventional block based video encoding is 2n×2m (n and m are natural numbers).

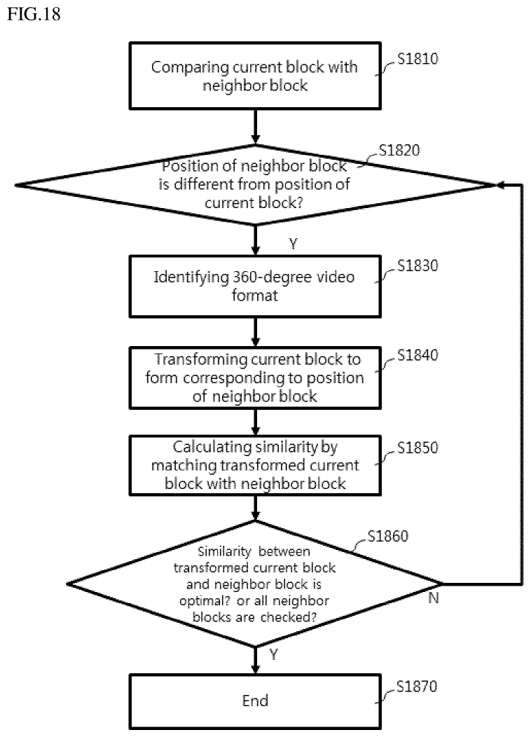

FIG. 18 is a view illustrating how an apparatus for deformable block based motion prediction operates according to an embodiment of the present disclosure.

At step S1810, the current block may be compared with the neighbor block to predict motion of the current block in the current frame. For example, the position of the neighbor block to be compared may be determined by varying the displacement.

At step S1820, whether the position of the current block is different from the position of the neighbor block may be determined. In the meantime, when predicting the merge candidate or the motion information, the neighbor block comparison may be skipped and step S1820 may be performed using the derived motion information.

As the determination result at step S1820, when the position of the current block is different from the position of the neighbor block, the format of the 360-degree video may be identified at step S1830. For example, formats of 360-degree video may include a projection format of the 360-degree video.

As the determination result at step S1820, when the position of the current block is the same as the position of the neighbor block, namely, when the displacement is (0, 0), the format of the 360-degree video may not be identified at step S1830.

At step S1840, the current block may be transformed into a form corresponding to the position of the neighbor block. For example, the neighbor block may be deformed according to the displacement of the moved motion vector. Alternatively, the current block may be deformed according to the displacement of the moved motion vector.

At step S1850, similarity may be calculated by matching the transformed current block with the neighbor block.

At step S1860, whether the similarity between the transformed current block and the neighbor block is optimal may be determined. Alternatively, at step S1860, whether similarities between each of all particular neighbor blocks and the current block have been calculated may be determined.

As the determination result at step S1860, when the similarity between the transformed current block and the neighbor block is optimal, similarity calculation may be terminated at step S1870.

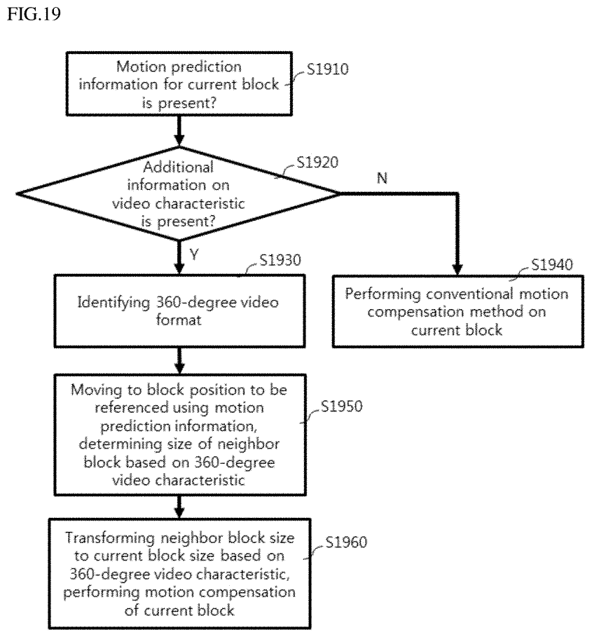

FIG. 19 is a view illustrating how an apparatus for deformable block based motion compensation operates according to an embodiment of the present disclosure.

At step S1910, whether there is motion prediction information for the current block may be determined. For example, prediction information of the current block may include motion information of the current block or the neighbor block.

At step S1920, whether there is additional information on the video characteristic may be determined.

As the determination result at step S1920, when there is additional information on the video characteristic, the format of the 360-degree video may be identified at step S1930. For example, formats of 360-degree video may include a projection format of the 360-degree video.

As the determination result at step S1920, when there is no additional information on the video characteristic, the conventional motion compensation method may be performed on the current block at step S1940.

At step S1950, the motion prediction information is used to move to the block position to be referenced, and based on information on the 360-degree video characteristic, the form of the neighbor block may be determined.

At step S1960, based on the 360-degree video characteristic, the neighbor block is transformed to the size of the current block and motion compensation for the current block may be performed.

The above embodiments may be performed in the same way in the apparatus for motion prediction and the apparatus for motion compensation.

The order of applying the embodiment may be differ in the apparatus for motion prediction and the apparatus for motion compensation. The order of applying the embodiment may be the same in the apparatus for motion prediction and the apparatus for motion compensation.

The apparatus for motion prediction may be an embodiment of an encoder.

The apparatus for motion compensation may be an embodiment of a decoder.

The above embodiments may be performed in the same method in an encoder and a decoder.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 or greater. For example, the above embodiments may be applied when a size of current block is 16×16 or greater. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type to which the above embodiments of the present invention are applied may be defined, and the above embodiments may be applied depending on the corresponding slice type.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

Various embodiments of the present disclosure are not presented to describe all of available combinations but are presented to describe only representative combinations. Steps or elements in various embodiments may be separately used or may be used in combination.

In addition, various embodiments of the present disclosure may be embodied in the form of hardware, firmware, software, or a combination thereof. When the present disclosure is embodied in a hardware component, it may be, for example, an application specific integrated circuit (ASIC), a digital signal processor (DSP), a digital signal processing device (DSPD), a programmable logic device (PLD), a field programmable gate array (FPGA), a general processor, a controller, a microcontroller, a microprocessor, etc.

The scope of the present disclosure includes software or machine-executable instructions (for example, operating systems (OS), applications, firmware, programs) that enable methods of various embodiments to be executed in an apparatus or on a computer, and a non-transitory computer-readable medium storing such software or machine-executable instructions so that the software or instructions can be executed in an apparatus or on a computer.

1. A method of deformable block based motion prediction, the method comprising:
detecting format information of a 360-degree video;
deforming at least one of a form of a current block and a form of a neighbor block by using the format information; and
predicting a motion vector for the current block based on the deformation.

2. The method of claim 1, wherein the format information includes a projection format of the 360-degree video.

3. The method of claim 1, wherein the form of the block includes at least one of a size and a shape of the block.

4. The method of claim 1, wherein when the 360-degree video is an ERP format video, the deforming includes deforming the form of the current block or the form of the neighbor block in consideration of a latitude in the 360-degree video where the current block or the neighbor block is positioned.

5. The method of claim 4, wherein the deforming further includes determining whether to change the form of the current block or the form of the neighbor block by comparing the latitude with a specific threshold value.

6. The method of claim 1, wherein when the 360-degree video is an ERP format video, the method further comprises performing padding on the 360-degree video by using at least one of left and right particular regions of the 360-degree video.

7. The method of claim 1, wherein when the 360-degree video is an ERP format video, the predicting of the motion vector for the current block includes:
deforming a form of a search region for the neighbor block in consideration of a latitude in the 360-degree video; and
predicting the motion vector for the current block based on the deformed search region.

8. The method of claim 1, wherein when the 360-degree video is an ERP format image and the prediction is bi-directional motion information prediction, the prediction of the motion vector includes:
predicting a first motion vector for the current block based on the deformation;
determining a specific scaling factor by using the predicted first motion vector and a position of the current block; and
predicting a second motion vector by using the scaling factor.

9. A method of deformable block based motion compensation, the method comprising:
receiving motion prediction information of a current block;
receiving format information of a 360-degree video; and
generating a prediction block for the current block by using the motion prediction information and the format information.

10. The method of claim 9, wherein the generating of the prediction block for the current block includes:
deforming at least one of a form of the current block and a form of a neighbor block by using the motion prediction information and the format information; and
generating the prediction block for the current block by using the deformed block.

11. An apparatus for deformable block based motion prediction, the apparatus being configured to:
detect format information of a 360-degree video;
deform at least one of a form of a current block and a form of a neighbor block by using the format information; and
predict a motion vector for the current block based on the deformation.

12. The apparatus of claim 11, wherein the format information includes a projection format of the 360-degree video.

13. The apparatus of claim 11, wherein the form of the block includes at least one of a size and a shape of the block.

14. The apparatus of claim 11, wherein when the 360-degree video is an ERP format video, the apparatus deforms the form of the current block or the form of the neighbor block in consideration of a latitude in the 360-degree video wherein the current block or the neighbor block is positioned.

15. The apparatus of claim 14, wherein the apparatus determines whether to change the form of the current block or the form of the neighbor block by comparing the latitude with a specific threshold value.

16. The apparatus of claim 11, wherein when the 360-degree video is an ERP format video, the apparatus performs padding on the 360-degree video by using at least one of left and right particular regions of the 360-degree video.

17. The apparatus of claim 11, wherein when the 360-degree video is an ERP format video, the apparatus deforms a form of a search region for the neighbor block in consideration of a latitude in the 360-degree video, and predicts the motion vector for the current block based on the deformed search region.

18. The apparatus of claim 11, wherein when the 360-degree video is an ERP format video and the prediction is bi-directional motion information prediction, the apparatus predicts a first motion vector for the current block based on the deformation, determines a specific scaling factor by using the predicted first motion vector and a position of the current block, and predicts a second motion vector by using the scaling factor.

19. An apparatus for deformable block based motion compensation, the apparatus being configured to:
receive motion prediction information of a current block;
receive format information of a 360-degree video; and
generate a prediction block for the current block by using the motion prediction information and the format information.

20. The apparatus of claim 19, wherein the apparatus deforms at least one of a form of the current block and a form of a neighbor block by using the motion prediction information and the format information, and generates the prediction block for the current block by using the deformed block.
